(19) United States
(12) Patent Application Publication
(10) Pub. No.: US 2003/0145084 A1
(43) Pub. Date: Jul. 31, 2003

(54) System and method for decentralized system and network performance assessment and verification

(76) Inventor: Shaun Charles McNerney, Colorado Springs, CO (US)

Correspondence Address: Law Office of Dale B. Halling, LLC, Suite 311, 24 South Weber Street, Colorado Springs, CO, 80903, US

(21) Appl. No.: 10/348,157

(22) Filed: Jan. 21, 2003

Related U.S. Application Data
(60) Provisional application No. 60/351,791, filed on Jan. 25, 2002.

(51) Int. Cl. G06F 15/173

(52) U.S. Cl. 709/224; 709/220

(57) ABSTRACT

A system for decentralized system and network performance assessment and verification that overcomes these and other problems includes an autonomous assessment and verification process that runs on a first computer system. A data network is coupled to the first computer system. A group assessment and verification process runs on a second computer system and is coupled to the network.

### RELATED APPLICATIONS

This patent claims priority on the provisional patent application entitled “System and Method for User-Centric Monitoring of Networked Computer Systems and Services”, filed on Jan. 25, 2002, and having application No. 60/351,791.

### FIELD OF THE INVENTION

The present invention relates generally to the field of computer software and more particularly to a system and method for decentralized system and network performance assessment and verification.

### BACKGROUND OF THE INVENTION

The number of corporations and individuals that use computer systems and connect their computer systems to data networks and to the Internet continues to rapidly grow. This growth in computer systems and data networks has resulted in the introduction of and the reliance on a growing number of services provided via data networks. This growth has resulted in a significant number of users with little to no technical experience on how the computer system or data network operates. This growth has also triggered an increase in the complexity of data networks which means that a greater number of combinations and permutations need to be tested and monitored to know if everything is operational and working for an end-user to be able to accomplish their desired/required tasks.

The main objective of testing and monitoring is to determine if the resources required to complete required tasks are available and operational. The present products directed to this problem use a centralized approach. Unfortunately, a centralized system cannot determine from an end user's point of view if the various network resources are available and operational.

Thus there exists a need for a system that provides decentralized performance assessment and verification of system and network resources.

### SUMMARY OF INVENTION

A system for decentralized system and network performance assessment and verification that overcomes these and other problems includes an autonomous assessment and verification process that runs on a first computer system. A data network is coupled to the first computer system. A group assessment and verification process runs on a second computer system and is coupled to the network. In one embodiment, the autonomous assessment and verification process assesses a system resource of the first computer system. The system resource may be a system memory, a central processing unit, a mass storage, a running application, or a network interface.

In one embodiment, the autonomous assessment and verification process transmits an assessment data to the group assessment and verification process. In one embodiment, a network monitoring system is coupled to the data network. In another embodiment, the group assessment and verification process is coupled to a database that stores an assessment profile for the autonomous assessment and verification process running on a first computer system.

In one embodiment, a system for decentralized system and network performance assessment and verification has a number of autonomous assessment and verification processes running on a number of computer systems. A data network is coupled to the computer systems. A group assessment and verification process runs on a group computer system and is coupled to the data network. In one embodiment, each of the autonomous assessment and verification processes assesses a system resource. In another embodiment, each of the autonomous assessment and verification processes assesses a network resource. A network resource may be a communication rate between one of the plurality of computer systems and the data network or an availability of reading a data file from a network file share on a local server.

In one embodiment, a database is coupled to the group assessment and verification process. The database stores an assessment and verification profile for at least one of the autonomous assessment and verification processes. In one embodiment, the assessment and verification profile defines an assessment and verification task.

In one embodiment, the group assessment and verification process receives an assessment and verification information from each of the autonomous assessment and verification processes.

In one embodiment, a method of decentralized system and network performance assessment and verification includes the steps of receiving an assessment and verification profile at a first computer system from a group assessment and verification process running on a group computer system. Next, a task of the assessment and verification profile is performed. A result of the task is reported to the group assessment and verification process. In one embodiment, a number of assessment and verification profiles are receive at a number of computer systems. In one embodiment, one of the tasks of the assessment and verification profile is performed for each of the computer systems. In another embodiment, each of the tasks in the assessment and verification profile are performed.

In one embodiment, an assessment of a system resource is performed.

### BRIEF DESCRIPTION OF THE DRAWINGS

FIG. 1 is a block diagram of a system for decentralized system and network performance assessment and verification in one embodiment;

FIG. 2 is a schematic diagram of the tasks performed by an autonomous assessment and verification process in one embodiment of the invention;

FIG. 3 is a diagram of a group assessment and verification process coupled to assessment profiles in accordance with one embodiment of the invention; and

FIG. 4 is a flow chart of the steps used in a method for decentralized system and network performance assessment and verification in one embodiment.

### DETAILED DESCRIPTION OF THE DRAWINGS

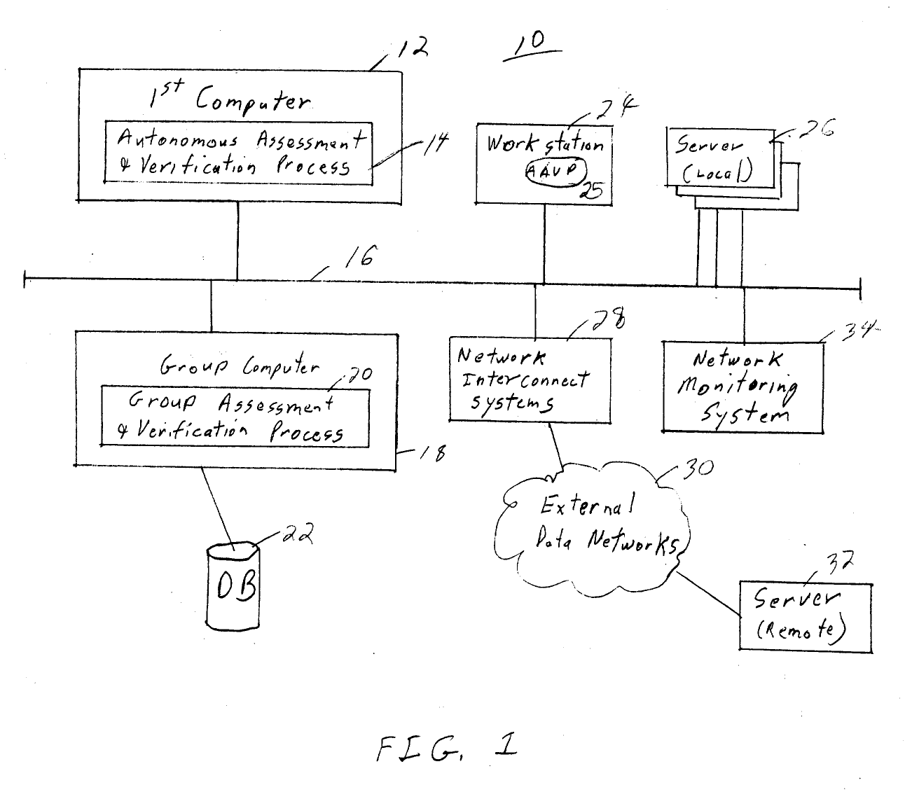

FIG. 1 is a block diagram of a system for decentralized system and network performance assessment and verification 10 in one embodiment. The system 10 has a first computer 12 which runs an autonomous assessment and verification process 14. The first computer 12 is coupled to a data network 16. A group computer or second computer 18 is also coupled to the data network 16. A group assessment and verification process 20 runs on the group computer 18. A database 22 is coupled to the group computer 18. A workstation 24 is coupled to the data network 16 and runs the autonomous assessment and verification process (AAVP) 25. In one embodiment a number of local servers 26 are coupled to the data network 16. Each of the local servers may have the autonomous assessment and verification process running. A network interconnect system 28 couples the data network 16 to an external data network 30 (e.g., the Internet). A remote server 32 may be attached to the external data network 30. The remote server 32 may have the autonomous assessment and verification process running. In one embodiment, a network monitoring system 34 is coupled to the data network 16.

The first computer system 12 has a number of system resources such as processes, services, CPU, memory, storage, software modules, software applications and others. In addition, the first computer system 12 has a number of network resources such as network software, network drivers, network interface, cabling, connectors, connection status, speed, link quality, errors and others. All these system and network resources need to be assessed and verified. Each of the other computer systems 18, 24, 26, 28, 32 have similar system and network resources that need to be assessed and verified. The autonomous assessment and verification processes 14, 25 are used to check these resources and make sure they are available and operational within the required limits when an end user needs them to accomplish their job. Each of the autonomous assessment and verification processes 14, 25 report assessment and verification information to the group assessment and verification process 20. The group assessment and verification process 20 aggregates, stores and acts on this information. For instance, each of the autonomous assessment and verification processes may be reporting that an email server is down. The group assessment and verification process will send a message to the autonomous assessment and verification processes and direct them to stop testing the email server's availability for a certain period of time. The assessment and availability information is reported to an end user. The report is in text form and may also include a visual, auditory or other sensory indicator. The database 22 also contains a plurality of assessment profiles. In one embodiment, there is an assessment profile for each of the computer systems. In another embodiment, there is an assessment profile for each user of the computer systems. The network monitoring system 34 is a legacy system that receives assessment data from the group assessment and verification processes 20.

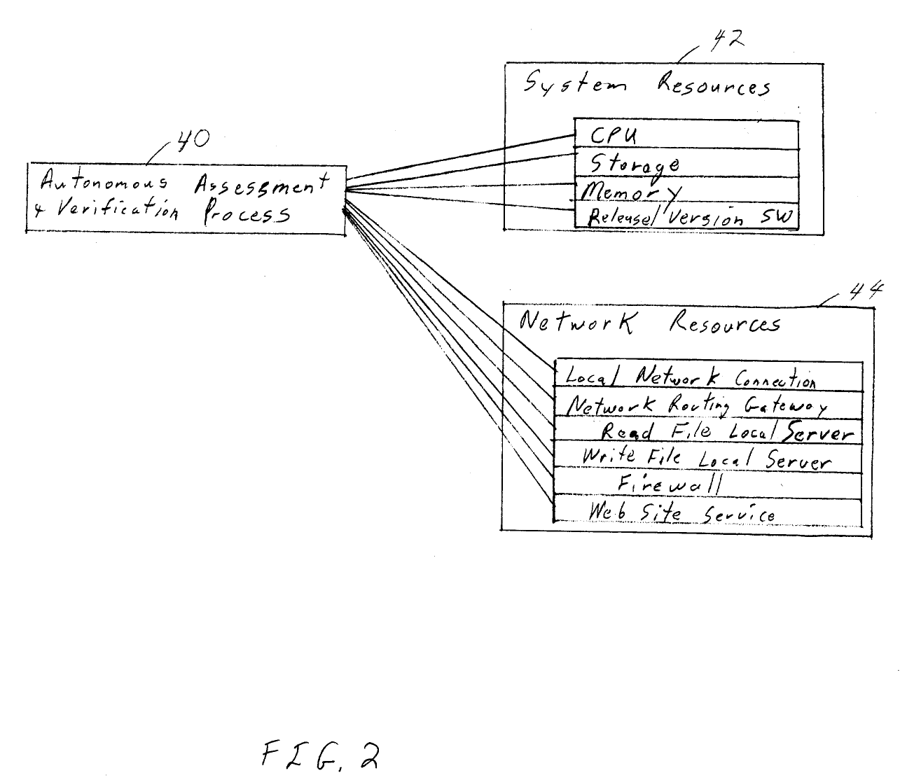

FIG. 2 is a schematic diagram of the tasks performed by an autonomous assessment and verification process 40 in one embodiment of the invention. The autonomous assessment and verification process 40 receives a set of tasks to be performed as part of an assessment profile. These tasks may be broken down into system resources tasks 42 and network resources tasks 44. Some examples of system resources tasks include:

1) assess a CPU (central processing unit) for sustain 60% or higher usage over a five minute interval;

2) assess the free disk space available for at least 200M Bytes;

3) assess the free memory over a five minute interval for at least 5M Bytes;

4) assess the operating software release version and determine if a newer version is available.

Some examples of the network resources tasks include:

1) assess the connection speed to the local data network 16 (FIG. 1) for a sustained 10M Bit/second or higher transmission rate over a five minute interval;

2) assess the availability of a network routing gateway over a ten minute interval;

3) assess the availability of reading a data file from a network file share on a local server 25 (FIG. 1) over a thirty minute interval;

4) assess the availability of writing a data file to a network file share on a local server 25 (FIG. 1) over a thirty minute interval;

5) assess the availability of a network firewall interconnect system 28 (FIG. 1) over a fifteen minute interval;

6) assess the availability of a web site service (i.e., a URL) on a remote server 32 (FIG. 1) over a 45 minute interval.

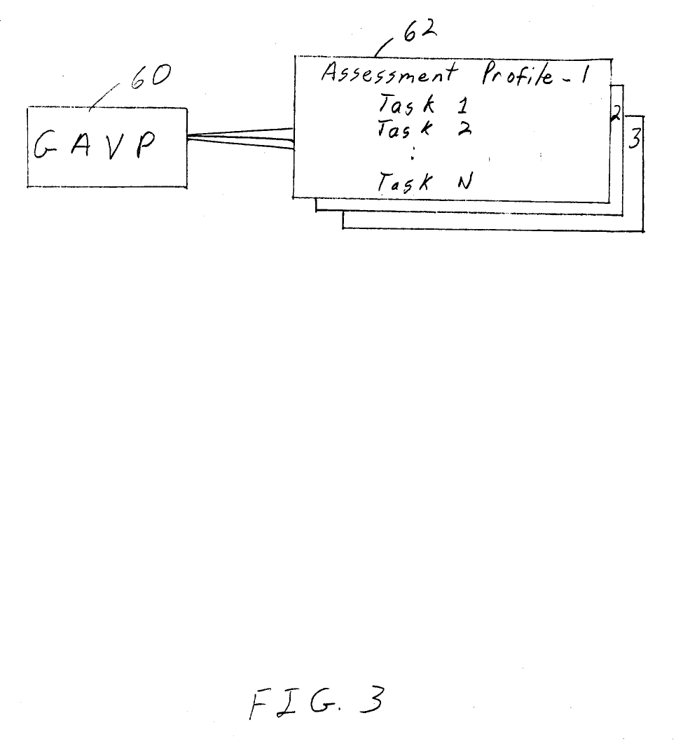

FIG. 3 is a diagram of a group assessment and verification process 60 coupled to assessment profiles 62 in accordance with one embodiment of the invention. The group assessment and verification process 60 provides the assessment profiles 62 to the appropriate autonomous assessment and verification processes. The assessment profiles 62 are stored in the database 22 (FIG. 1). The assessment profiles 62 define a number of tasks for a computer system to perform. The tasks detailed with respect to FIG. 2 are representative of the type of tasks defined in an assessment profile.

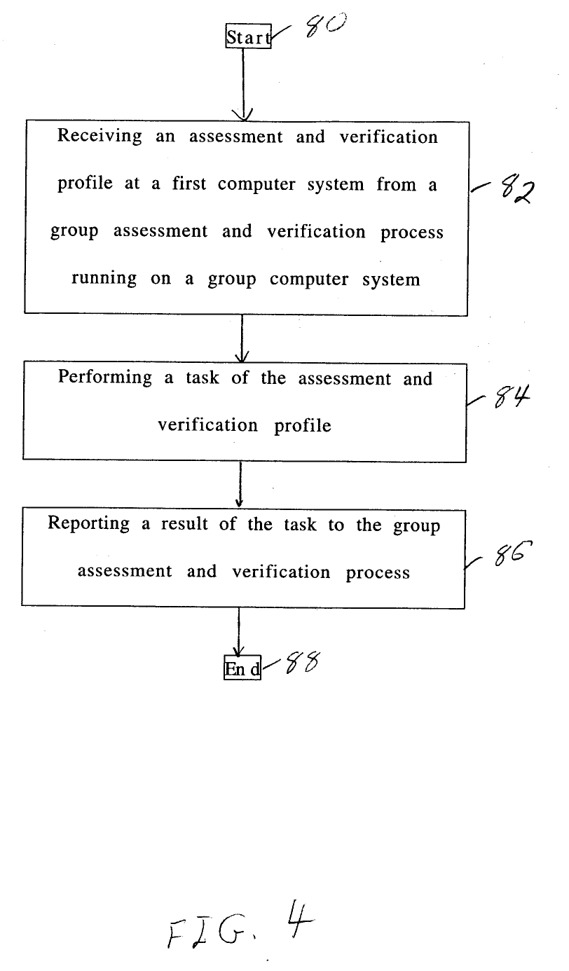

FIG. 4 is a flow chart of the steps used in a method for decentralized system and network performance assessment and verification in one embodiment. The process starts, step 80, by receiving an assessment and verification profile at a first computer from a group assessment and verification process running on a group computer at step 82. A task of the assessment and verification profile is performed at step 84. At step 86 a result of the task is reported to the group assessment and verification process which ends the process at step 88. In one embodiment, a number of assessment and verification profiles are received at a number of computer systems. In another embodiment, one of the tasks of the assessment and verification profile is performed for each of the computer systems. In yet another embodiment, each of the tasks in the assessment and verification profile are performed.

Thus there has been described a system and method for decentralized system and network performance assessment and verification that determines from an end user's point of view if the various system and network resources are available and operating within defined limits.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for decentralized system and network performance assessment and verification, comprising:
an autonomous assessment and verification process running on a first computer system;
a data network coupled to the first computer system; and
a group assessment and verification process running on a second computer system coupled to the network.

2. The system of claim 1, wherein the autonomous assessment and verification process assesses a system resource of the first computer system.

3. The system of claim 2, wherein the system resource is a system memory.

4. The system of claim 1, wherein the autonomous assessment and verification process transmits an assessment data to the group assessment and verification process.

5. The system of claim 1, further including a network monitoring system coupled to the data network.

6. The system of claim 5, wherein the group assessment and verification process transmits an assessment data to the network monitoring system.

7. The system of claim 1, wherein the group assessment and verification process is coupled to a database that stores an assessment profile for the autonomous assessment and verification process running on a first computer system.

8. A system for decentralized system and network performance assessment and verification, comprising:
a plurality of autonomous assessment and verification processes running on a plurality of computer systems;
a data network coupled to the plurality of computer systems; and
a group assessment and verification process running on a group computer system coupled to the data network.

9. The system of claim 8, wherein each of the autonomous assessment and verification processes assesses a system resource.

10. The system of claim 8, wherein each of the autonomous assessment and verification processes assesses a network resource.

11. The system of claim 10, wherein a network resource is a sustained transmission rate between one of the plurality of computer systems and the data network.

12. The system of claim 8, wherein a network resource is an availability of reading a data file from a network file share on a local server.

13. The system of claim 8, further including a database coupled to the group assessment and verification process, wherein the database stores an assessment and verification profile for at least one of the plurality of autonomous assessment and verification processes.

14. The system of claim 13, wherein the assessment and verification profile defines a plurality of assessment and verification tasks.

15. The system of claim 8, wherein the group assessment and verification process receives an assessment and verification information from each of the plurality of autonomous assessment and verification processes.

16. A method of decentralized system and network performance assessment and verification, comprising the steps of:
a) receiving an assessment and verification profile at a first computer system from a group assessment and verification process running on a group computer system;
b) performing a task of the assessment and verification profile; and
c) reporting a result of the task to the group assessment and verification process.

17. The method of claim 16, wherein step (a) includes the step of:
a1) receiving a plurality of assessment and verification profiles at a plurality of computer systems.

18. The method of claim 16, wherein step (b) includes the step of:
(b1) performing one of the tasks of the assessment and verification profile for each of a plurality of computer systems.

19. The method of claim 16, wherein step (b) includes the step of:
(b1) performing each of a plurality of tasks in the assessment and verification profile.

20. The method of claim 16, wherein step (b) includes the step of:
b1) performing an assessment of a system resource.
